(19) United States
(12) Patent Application Publication
(10) Pub. No.: US 2005/0102327 A1
(43) Pub. Date: May 12, 2005

(54) Data file processor, data file processing method and program

(75) Inventors: Toshio Manki, Kyoto (JP); Ryousuke Kamibayashi, Kyoto (JP)

Correspondence Address: MCDERMOTT, WILL & EMERY, 600 13th Street, N.W., WASHINGTON, DC, 20005-3096, US

(73) Assignee: DAINIPPON SCREEN MFG. CO., LTD.

(21) Appl. No.: 10/973,433

(22) Filed: Oct. 27, 2004

(30) Foreign Application Priority Data
Nov. 11, 2003 (JP) JP2003-380751
May 28, 2004 (JP) JP2004-158495

(51) Int. Cl. G06F 17/30

(52) U.S. Cl. 707/200

(57) ABSTRACT

A data file processor displays a processing content set area corresponding to the processing content of a data file on a display part. The data file processor creates an input area for inputting the data file in the processing content set area. The data file processor sets a parameter necessary for processing the data file in the input area. The data processor inputs the data file to be processed in this input area thereby processing the data file with the processing content corresponding to the processing content set area through the parameter. Thus, creation of the input area (hot folder) is simplified while an input error of the data file with respect to the hot folder can be prevented.

### BACKGROUND OF THE INVENTION

1. Field of the Invention

The present invention relates to a data file processor processing a data file, a data file processing method and a program. More particularly, the present invention relates to a data file processing technique utilizing GUI (graphical user interface).

2. Description of the Background Art

A generally used computer implements a technique of setting a processing content and parameters for a folder and automatically processing a data file input in the folder on the basis of the processing content and the parameters set therefor. This folder is referred to as a hot folder or a drop folder. The hot folder can be created on the screen of a display part. The data file can be input in the hot folder through the well-known drag and drop operation. Therefore, an operator can process the data file with the hot folder through a general operation.

A plurality of such hot folders must be created in response to the contents of processing to be executed. Therefore, the operator must set the processing content every time he/she creates a hot folder, disadvantageously leading to a remarkable burden.

When a large number of hot folders are created on the same screen, data files may be falsely input. When a large number of hot folders are created on a desktop screen on which a plurality of other icons are also arranged, data files are further readily falsely input.

When data files are simultaneously input in a plurality of hot folders, further, it is difficult to determine which folder currently executes processing.

### SUMMARY OF THE INVENTION

The present invention is directed to a data file processor.

According to the present invention, the data file processor comprises an operating part, a display part, an output part displaying a processing content set area corresponding to a processing content on the display part, a creation part creating an input area for inputting the data file in the processing content set area, a parameter set part setting a parameter necessary for executing processing corresponding to the processing content set area to which the input area belongs for the input area, an input part inputting the data file specified by the operating part in the input area and an execution part executing processing of the data file input in the input area. The execution part executes the processing corresponding to the processing content set area to which the input area belongs with the parameter set for the input area.

It follows that the data file processor creates the input area for executing the corresponding processing, i.e., a hot folder, in the processing content set area. Thus, the data file processor can readily create the hot folder. Further, the data file processor can prevent the data file from false input.

Preferably, the data file processor further comprises a processing content set part setting a processing content on the basis of an operation from an operator, and the output part displays the processing content set area corresponding to the processing content set by the processing content set part on the display part.

The data file processor can display the processing content set area with the processing content desired by the operator. Further, the data file processor can readily create a hot folder desired by the operator.

Preferably, the output part displays a plurality of processing content set areas corresponding to a plurality of processing contents on the display part.

The data file processor can readily create hot folders corresponding to the respective ones of the plurality of processing contents. Further, the data file processor, displaying the plurality of processing content set areas in correspondence to the respective ones of the plurality of processing contents, can prevent data files from false input in the hot folders.

Preferably, the creation part creates a plurality of the input areas in the processing content set area, and the parameter set part is capable of setting different parameters for the respective ones of the plurality of input areas.

The data file processor can readily create a plurality of hot folders, corresponding to the same processing content, different only in parameters from each other.

Preferably, the data file processor further comprises a status output part displaying the status of the processing in the execution part on the display part.

The data file processor can readily comprehend the status of the processing in the hot folder.

Preferably, the data file processor further comprises an identification part identifying whether or not the processing corresponding to the processing content set area to which the input area belongs is executable for the data file when the data file is input in the input area.

The data file processor can further prevent the data file from false input in the hot folder.

The present invention is also directed to a data file processing method and a program.

Accordingly, an object of the present invention is to provide a technique capable of readily creating a hot folder and preventing a data file from false input in the hot folder. Another object of the present invention is to provide a technique capable of readily determining the status in each of a plurality of hot folders.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows the structure of a data file processor according to a first preferred embodiment of the present invention;

FIG. 2 is a flow chart of operations of the data file processor according to the first preferred embodiment;

FIG. 3 shows an exemplary processing content set area;

FIGS. 4A and 4B illustrate input areas created in the processing content set area;

FIGS. 5A, 5B and 5C illustrate processing for inputting a data file in an input area;

FIG. 6 shows the structure of a data file processor according to a second preferred embodiment of the present invention;

FIG. 7 shows the structure of a data file processor according to a third preferred embodiment of the present invention; and

FIGS. 8A and 8B illustrate operations of the data file processor according to the third preferred embodiment.

### DESCRIPTION OF THE PREFERRED EMBODIMENTS

Best preferred embodiments of the present invention are now described with reference to the drawings.

### 1. First Preferred Embodiment

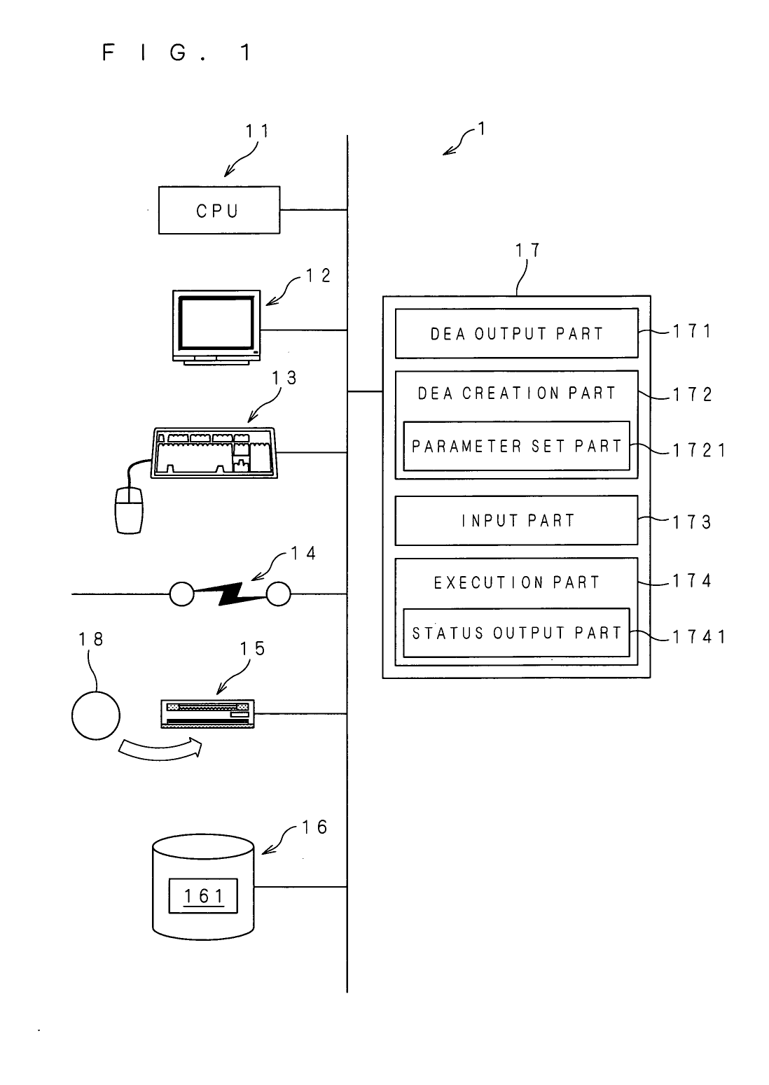

FIG. 1 shows the structure of a data file processor 1 according to a first preferred embodiment of the present invention. The data file processor 1, having a structure similar to that of a generally used personal computer, mainly comprises a CPU 11, a display part 12, an operating part 13, an interface 14, a media drive 15, a storage part 16 and a memory 17.

The CPU 11 controls the overall data file processor 1. In particular, the CPU 11 runs a program 161 recorded in a media disk 18 inserted into the media drive 15 in the memory 17, thereby implementing functions of the data file processor 1.

The display part 12 displays information necessary for processing data files. In particular, the display part 12 displays processing content set areas DEA and input areas DIA described later. This display part 12 is formed by a CRT display or an LCD display, for example.

The operating part 13 is constituted of a mouse, a keyboard etc. An operator operates this operating part 13 for inputting instructions in the data file processor 1. In particular, the operator operates the operating part 13 for creating the input areas DIA, setting parameters for the input areas DIA and inputting data files DF displayed in the form of icons in the input areas DIA.

The interface 14 connects the data file processor 1 with a network (not shown). The data file processor 1 can receives data files DF to be processed from a terminal (not shown) connected to the network through the interface 14. The data file processor 1 can also download the program 161 for implementing the functions thereof from a server (not shown).

The media drive 15 reads the program 161 recorded in the media disk 18. The program 161 read by the media drive 15 implements the functions of the data file processor 1.

The storage part 16 stores the program 161 read by the media drive 15. This storage part 16 is formed by a hard disk, for example.

The memory 17 is a work area for the CPU 11 for running the program 161 stored in the storage part 16. When the CPU 11 runs the program 161, the memory 17 implements functions of a DEA output part 171, a DIA creation part 172, an input part 173 and an execution part 174.

The DEA output part 171 displays the processing content set areas DEA on the display part 12. The processing content set areas DEA are areas for creating the input areas DIA. The processing content set areas DEA correspond to setting of processing contents in the execution part 174. When any data file DF is input in an input area DIA created in a certain processing content set area DEA, therefore, the execution part 174 processes this data file DF according to the processing content corresponding to this processing content set area DEA.

The display part 12 can also display a plurality of processing content set areas DEA for the processing contents of the data files DF set in the execution part 174.

The DIA creation part 172 creates the input areas DIA in the processing content set areas DEA. The input areas DIA have functions similar to those of generally used hot folders. When the operator inputs any data file DF in the corresponding input area DIA through the input part 173, the execution part 174 executes processing corresponding to the processing content set area DEA to which the input area DIA belongs on this data file DF.

The DIA creation part 172 comprises a parameter set part 1721. The parameter set part 1721 sets parameters necessary for processing the data files DF in the execution part 174 for the input areas DIA. Parameters set for a certain input area DIA are necessary for executing the processing corresponding to the processing content set area DEA to which the input area DIA belongs. The parameter set part 1721 can set different parameters every input area DIA.

Therefore, the DIA creation part 172 can create a plurality of input areas DIA for which different parameters are set in each processing content set area DEA.

The input part 173 inputs the data files DF in the input areas DIA in response to the operation of the operating part 13 by the operator. The input part 173 inputs the data files DF displayed on the display part 12 in the form of icons in the input areas DIA according to a function of an OS (operating system: not shown). The input part 173 can input the data files DF by a general drag and drop operation or the like.

The input part 173 may utilize the function of the OS (not shown).

The execution part 174 processes the data files DF input in the input areas DIA created in the processing content set areas DEA. Prescribed processing contents are set in the execution part 174, in order to process the data files DF. When the operator inputs any data file DF in the corresponding input area DIA, the execution part 174 acquires the parameters set for the input area DIA. The execution part 174 processes the data file DF with the processing content corresponding to the processing content set area DEA to which this input area DIA belongs through the parameters.

The execution part 174 comprises a status output part 1741. When the execution part 174 processes any data file DF, the status output part 1741 displays the status of this processing on the display part 12. When the data file processor 1 is capable of multi-tasking operation, i.e., capable of simultaneously processing a plurality of data files DF, the status output part 1741 may display the statuses of processing of the plurality of data files DF.

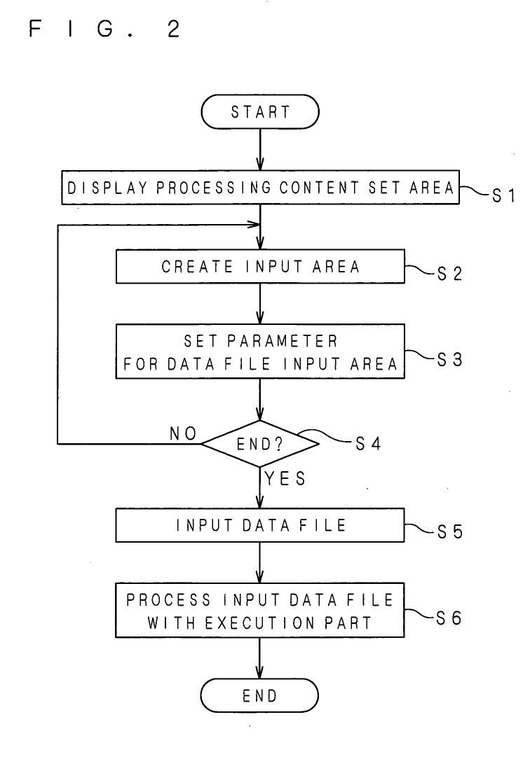

FIG. 2 is a flow chart showing operations of the data file processor 1.

At a step S1, the DEA output part 171 displays a processing content set area DEA corresponding to any processing content of the execution part 174. At this time, the DEA output part 171 acquires the processing content set in the execution part 174 and displays the processing content set area DEA corresponding to this processing content. If a plurality of processing contents are set in the execution part 174, the DEA output part 171 displays a plurality of processing content set areas DEA in correspondence to the respective processing contents.

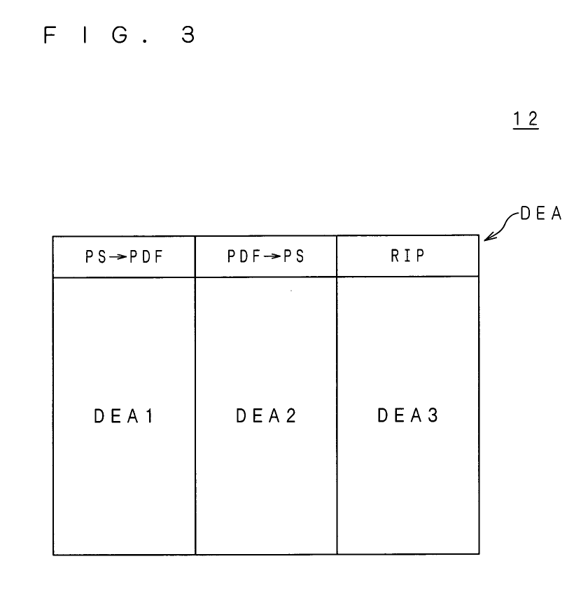

FIG. 3 illustrates an exemplary processing content set area DEA displayed on the display part 12 when the data file processor 1 carries out the step S1. The processing content set area DEA shown in FIG. 3 comprises a plurality of processing content set areas DEA1, DEA2 and DEA3. It is assumed here that three processing contents “PostScript→PDF”, “PDF→PostScript” and “RIP (Raster Image Processing)” are set in the execution part 174. The processing content set areas DEA1, DEA2 and DEA3 correspond to the processing contents “PostScript→PDF”, “PDF→PostScript” and “RIP” respectively.

PostScript is a registered trademark of Adobe Systems, and PDF is the abbreviation of “Portable Document Format”.

Referring again to FIG. 2, the DIA creation part 172 creates the input area DIA in the processing content set area DEA in response to an operation of the operator on the operating part 13 at a step S2. At this time, the operator of the data file processor 1 operates the operating part 13 to specify the desired processing content set area DEA and instruct the DIA creation part 172 to create the input area DIA in the processing content set area DEA. Then, the DIA creation part 172 creates the input area DIA in the specified processing content set area DEA. The created input area DIA performs operations similar to those of a general hot folder.

At a step S3, the parameter set part 1721 sets the parameters necessary for processing the data file DF in the input area DIA. At this time, the parameter set part 1721 sets the parameters necessary for the processing corresponding to the processing content set area DEA to which the input area DIA belongs. For example, the input area DIA created in the processing content set area DEA1 corresponding to the processing content “PostScript→PDF” requires the following parameters 1) to 5):

1) setting of the way of opening a PDF file

2) used font

3) on/off of trapping

4) embedded data object

5) document metadata

The parameter set part 1721 sets these parameters for the input area DIA created in the processing content set area DEA1.

The parameter set part 1721 can also set the parameters again after performing processing described later.

At a step S4, the operator decides whether or not the creation of the input area DIA at the step S2 and the parameter setting for the input area DIA at the step S3 have ended. In order to create a plurality of input areas DIA and set parameters for the input areas DIA, the operator returns to the step S2 for repeating the processing at the steps S2 and S3.

When the operator determines that the creation of the input area DIA and the parameter setting for the input area DIA have been ended, the data file processor advances to a step S5.

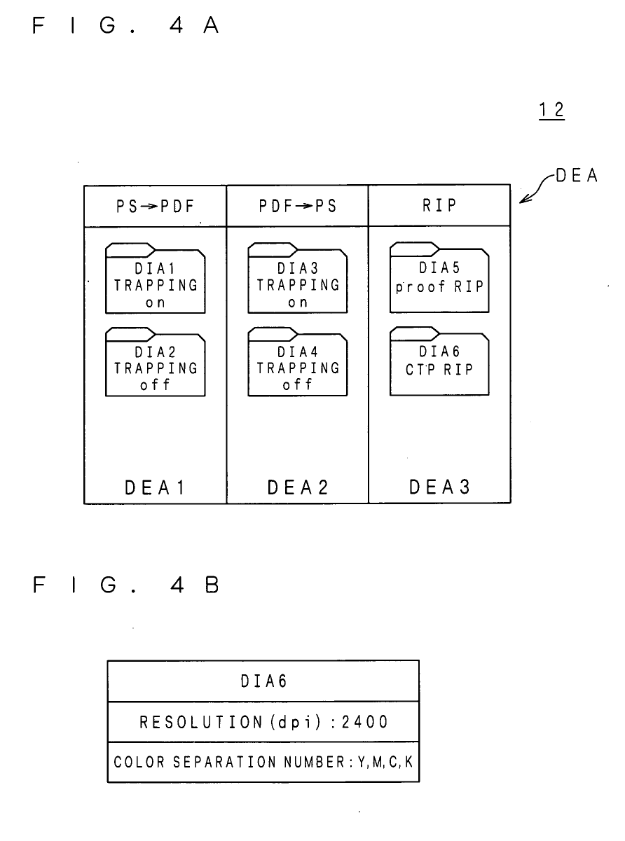

FIG. 4A shows a plurality of input areas DIA1 to DIA6 created in the processing content set areas DEA1 to DEA3 as a result of execution of the steps S2 and S3.

Referring to FIG. 4A, the input areas DIA1 and DIA2, DIA3 and DIA4 and DIA5 and DIA6 are crated in the processing content set areas DEA1, DEA2 and DEA3 respectively. The parameter set part 1721 sets different parameters for the input areas DIA1 to DIA6 created in the processing content set areas DEA1 to DEA3 respectively.

Comparing the input areas DIA1 and DIA2 with each other, for example, the parameter set part 1721 sets “trapping on” and “trapping off” for the input areas DIA1 and DIA2 respectively as to the parameter 3) on/off of trapping.

As shown in FIG. 4A, the input areas DIA1 and DIA2 are named as “trapping on” and “trapping off” respectively. Thus, the DIA creation part 172 desirably assigns names readily understandable for the operator to the input areas DIA1 to DIA6 in response to the set parameters.

FIG. 4B shows exemplary parameters set by the parameter set part 1721 for the input area DIA6 in the processing content set area DEA3. In this case, the parameter set part 1721 so sets the parameters that the resolution in RIP is “2400 dpi” and the number of created color separations is for four colors Y, M, C and K, as shown in FIG. 4B.

While the number of the processing content set areas DEA1 to DEA3 is three and the number of the input areas DIA1 to DIA6 is six in the above description, the numbers of the processing content set areas DEA and the input areas DIA are not restricted to three and six respectively. Further, the number of the parameters set for each input area DIA are not restricted to the above either.

Referring again to FIG. 2, at the step S5, input part 173 inputs the data file DF in the input area DIA according to an operation of the operating part 13 by the operator. At this time, the operator operates the operating part 13 for specifying the data file DF displayed on the display part 12 in the form of an icon. The operator further operates the operating part 13 for moving the specified data file DF on the screen and arranging the same on the desired input area DIA. Upon this operation, the input part 173 assumes that the specified data file DF has been input in the input area DIA. Thereafter the data file processor 1 advances to a step S6.

At the step S6, the execution part 174 acquires the parameters set for the input area DIA and processes the data file DF input in the input area DIA with the processing content corresponding to the processing content set area DEA through the parameters. When the input part 173 inputs the data file DF in the input area DIA at the step S5, the execution part 174 acquires the parameters set by the parameter set part 1721 for the input area DIA. The execution part 174 confirms the processing content set area DEA to which the input area DIA receiving the data file DF belongs, for processing the data file DF with the processing content corresponding to the processing content set area DEA through the parameters.

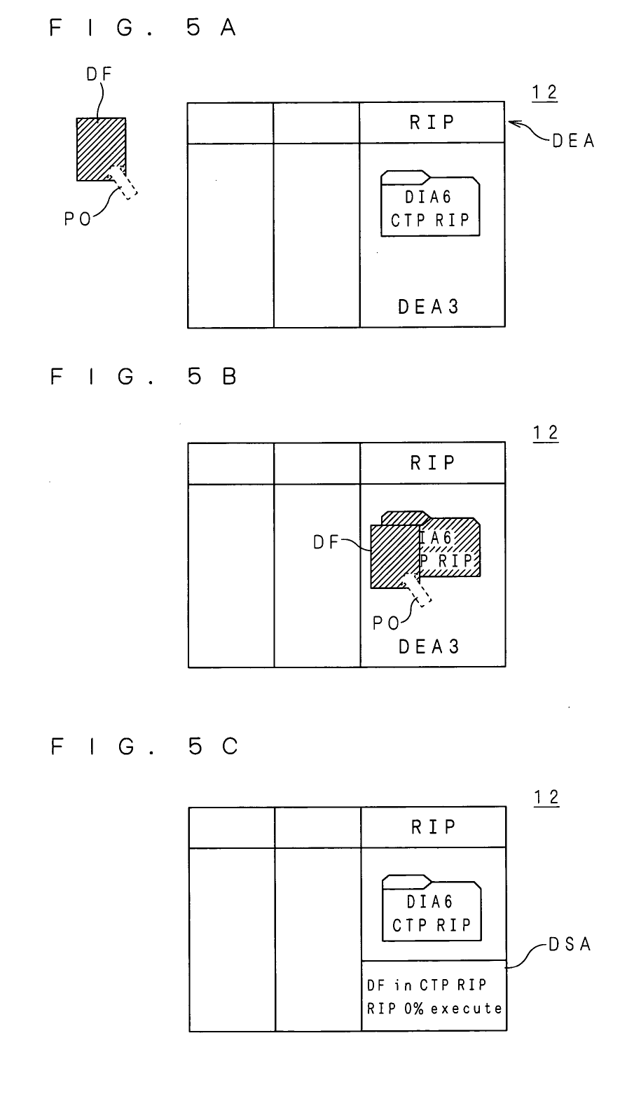

FIGS. 5A, 5B and 5C illustrate the operation at the step S6. Referring to FIG. 5A, the display part 12 displays a pointer PO operated by the operator, the data file DF in the form of an icon and the processing content set area DEA having a plurality of areas.

The input area DIA6 is displayed in the processing content set area DEA3. The operator operates the operating part 13 for moving the pointer PO and specifying the data file DF. The display part 12 reverses or highlights the specified data file DF, in order to indicate that this data file DF is specified. Referring to FIG. 5A, the display part 12 hatches the specified data file DF.

Referring to FIG. 5B, the operator further operates the operating part 13 for moving the specified data file DF onto the input area DIA6 created in the processing content set area DEA3. The operator operates the operating part 13 for moving the data file DF on the screen while specifying the data file DF with the pointer PO. This is referred to as “drag operation”. When the operator locates the specified data file DF on the input area DIA6, the display part 12 also reverses or highlights the input area DIA6 as that specified by the operator. Referring to FIG. 5B, the display part 12 also hatches the specified input area DIA6 similarly to the data file DF.

FIG. 5C shows the specified data file DF input in the input area DIA6 due to an operation of the operating part 13 by the operator. When the operator operates the operating part 13 and cancels the specification of the data file DF in the state shown in FIG. 5B, the input part 173 assumes that the data file DF has been input in the input area DIA6 on which the data file DF is located. This is referred to as “drop operation”. Thereafter the execution parts 174 starts processing the data file DF.

When the data file DF is input in the input area DIA6, the execution part 174 acquires the parameters set for the input area DIA6. At this time, the execution part 174 acquires the parameters set in FIG. 4B, i.e., “resolution: 2400 dpi” and “color separation number: Y, M, C and K”.

Then, the execution part 174 confirms the processing content set area DEA3 in which the input area DIA6 is created. In this case, the execution part 174 determines that the input area DIA6 belongs to the processing content set area DEA3 and the processing content is RIP.

The execution part 174 performs the RIP corresponding to the processing content set area DEA3 on the data file DF with the parameters acquired from the input area DIA6. At this time, the execution part 174 starts the status output part 1741. The status output part 1741 displays a status display area DSA in the processing content set area DEA3 on the basis of the processing content for the data file DF and the status of the processing in the execution part 174.

In the state shown in FIG. 5C, the execution part 174 starts performing the RIP corresponding to the processing content set area DEA3 on the data file DF with the parameters set for the input area DIA6 through the operation shown in FIG. 5B. As shown in FIG. 5C, the status display area DSA is displayed in the processing content set area DEA3. Immediately after the data file DF is input in the input area DIA6, the status of the processing performed by the execution part 174 on the data file DF is displayed as “RIP: 0% execute”. The status of the data file DF displayed on the status display area DSA is varied with a lapse of time and progress of the processing of the execution part 174.

While the processing of inputting the data file DF in the single input area DIA6 created in the single processing content set area DEA3 has been described, the processing according to the present invention is not restricted to this case. Also when one or a plurality of data files DF are input in a plurality of input areas DIA created in a plurality of processing content set areas DEA, for example, the data file processor 1 can process the data files DF through the processing at the steps S1 to S6.

Thus, the data file processor 1 shown in FIG. 1 operates along the flow chart shown in FIG. 2, thereby creating the input areas DIA, i.e., hot folders, in the processing content set areas DEA on the basis of the processing contents thereof. Therefore, the data file processor 1 can readily create the hot folders. Further, the data file processor 1 creates the hot folders for processing the data files DF in the processing content set areas DEA. Thus, the data file processing can prevent the data files DF from false input.

### 2. Second Preferred Embodiment

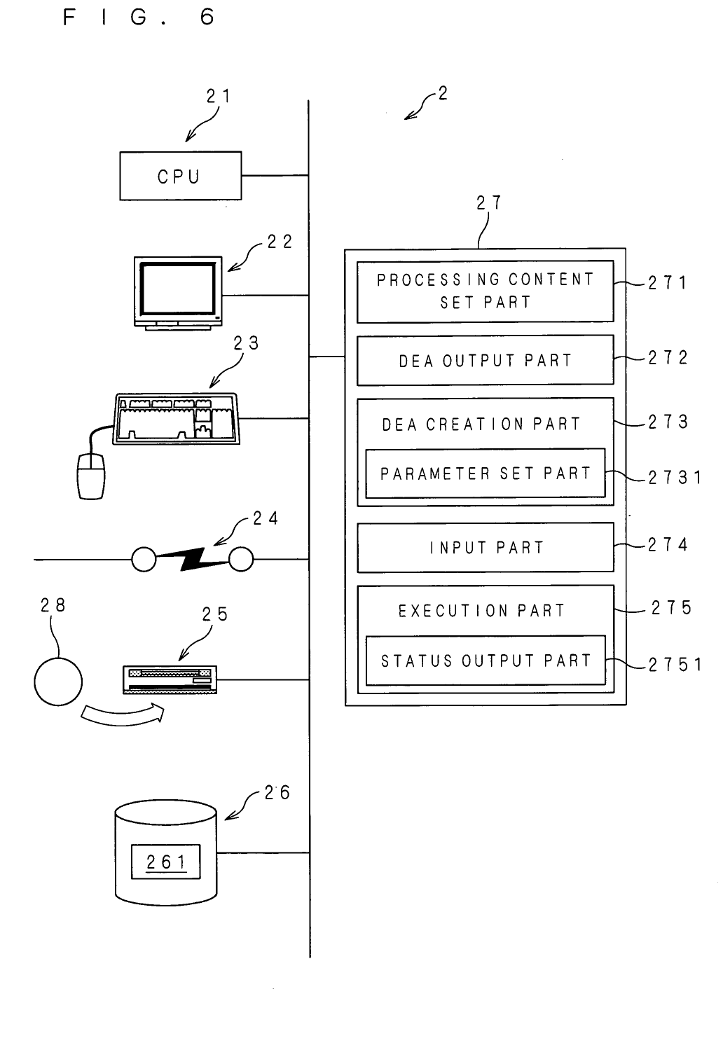

A data file processor 2 according to a second preferred embodiment of the present invention can take a structure shown in FIG. 6. The data file processor 2 shown in FIG. 6 comprises a processing content set part 271. The processing content set part 271 can set processing contents of data files DF in an execution part 274. Therefore, the data file processor 2 can display processing content set areas DEA with processing contents desired by an operator. Therefore, the data file processor 2 can readily create hot folders desired by the operator.

The remaining parts of the data file processor 2 shown in FIG. 6 are similar in structure to those of the aforementioned data file processor 1 according to the first preferred embodiment, and hence redundant description is omitted.

### 3. Third Preferred Embodiment

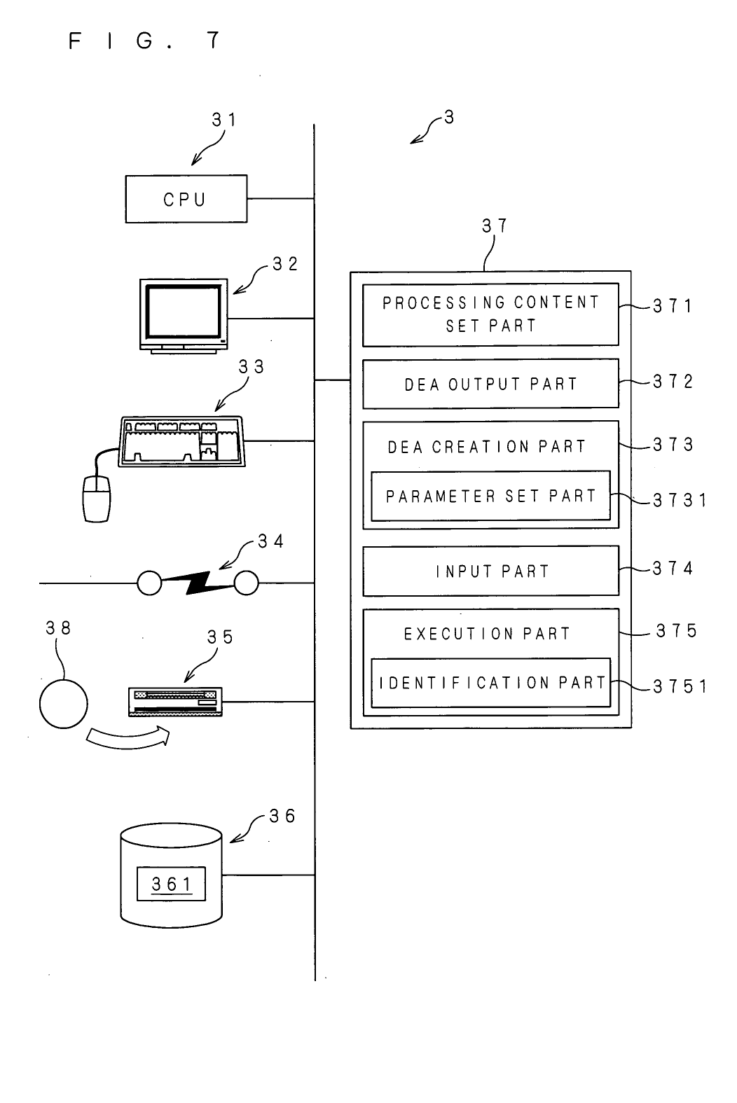

A data file processor 3 according to a third preferred embodiment of the present invention can take a structure shown in FIG. 7. The data file processor 3 shown in FIG. 7 comprises an identification part 3751. The identification part 3751 identifies the attributes of data files DF input in input areas DIA by an input part 374 for determining whether or not the data files DF are processible in response to processing contents set for processing content set areas DEA to which the input areas DIA belong. The identification part 3751 refers to extensions assigned to the data files DF for identifying the attributes of the data files DF. Alternatively, the identification part 3751 may refer to internal information of the data files DF for identifying the attributes of the data files DF.

The remaining parts of the data file processor 3 shown in FIG. 7 are similar in structure to those of the aforementioned data file processor 1 according to the first preferred embodiment, and hence redundant description is omitted.

When the input part 374 moves any data file DF to the corresponding input area DIA, the identification part 3751 identifies the attribute of the data file DF. When determining that the data file DF is processible with a processing content set for the corresponding processing content set area DEA as a result of identification of the attribute of the data file DF, the identification part 3751 authorizes the data file DF to be input in the input area DIA. Thereafter an execution part 375 processes the data file DF on the basis of the processing content set for the processing content set area DEA through parameters set for the input area DIA receiving the data file DF.

When determining that the data file DF is unprocessible with the processing content set for the corresponding processing content set area DEA as a result of identification of the attribute of the data file DF, the identification part 3751 inhibits the data file DF from input in the input area DIA. Thereafter the identification part 3751 displays that the data file DF is unprocessible in the input area DIA on a display part 32.

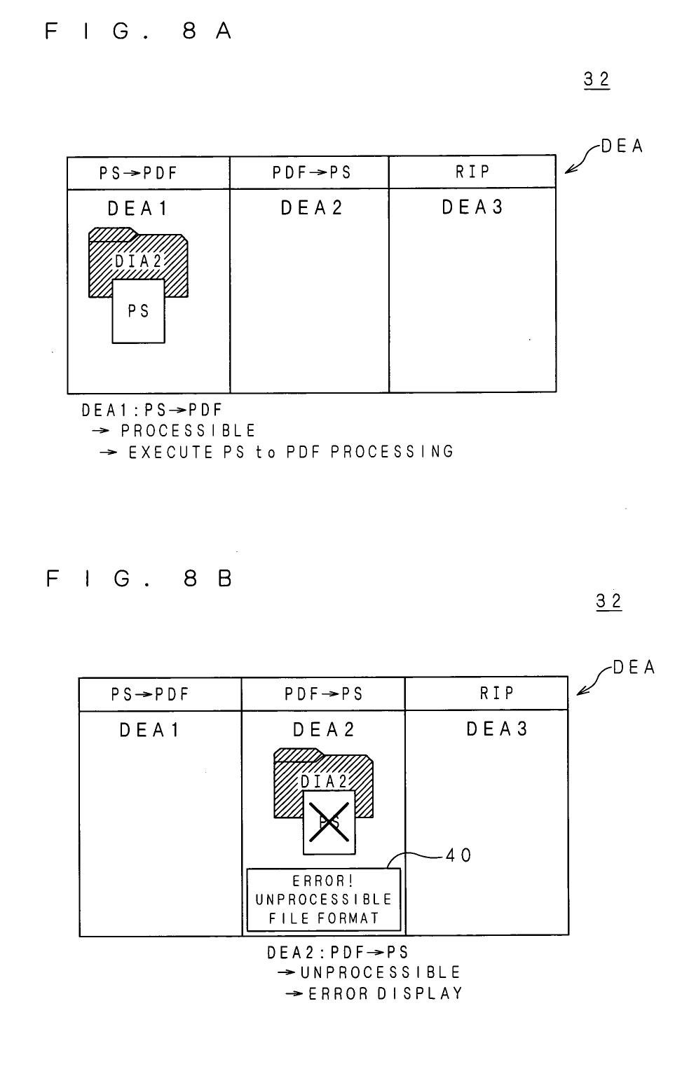

FIGS. 8A and 8B show operations of the identification part 3751 in the data file processor 3. Referring to FIGS. 8A and 8B, “PostScript→PDF”, i.e., processing of converting PostScript to PDF is set in a processing content set area DEA1. Further, “PDF→PostScript”, i.e., processing of converting PDF to PostScript is set in another processing content set area DEA2.

Referring to FIG. 8A, a PostScript file is input in an input area DIA1 as the data file DF. When the input part 374 moves the data file DF to the input area DIA1 of the processing content set area DEA1, the identification part 3751 identifies the attribute of the data file DF. In this case, the identification part 3751 determines that the data file DF is processible with the processing content set for the processing content set area DEA1 since the data file DF is the PostScript file and the processing content set for the processing content set area DEA1 is “PostScript→PDF”. Then, the identification part 3751 authorizes the data file DF to be input in the input area DIA1. The execution part 375 converts PostScript to PDF as to the data file DF input in the input area DIA1 with the parameters set for the input area DIA1.

Referring to FIG. 8B, on the other hand, an operator tries to input the data file DF which is the PostScript file in another input area DIA2. Similarly to the operation in FIG. 8A, the identification part 3751 identifies the attribute of the data file DF moved to the input area DIA2. In this case, the identification part 3751 determines that the data file DF has an attribute unprocessible with a processing content set for the processing content set area DEA2 since the data file DF is the PostScript file and the processing content set for the processing content set area DEA2 is “PDF→PostScript”. The identification part 3751 rejects input in the input area DIA2 as to the data file DF. Then, the identification part 3751 outputs a display 40 indicating that the data file DF is unprocessible in the processing content set area DEA2 to a display part 32.

The identification part 3751 may alternatively identify the attribute of the data file DF when the input part 374 moves the data file DF onto the processing content set area DEA. Also in this case, the identification part 3751 can determine whether or not the data file DF is processible with the processing content set for the processing content set area DEA by comparing the processing content set for the processing content set area DEA and the attribute of the data file DF with each other.

Thus, the data file processor 3 shown in FIG. 7 can further prevent the data file DF from false input by executing the operations shown in FIGS. 8A and 8B.

### 4. Modifications

Event-driven processing of inputting any data file DF in the corresponding input area DIA has been described with reference to each of the above preferred embodiments. Alternatively, the input part 173, 274 or 374 may recognize that the data file DF has been input in the input area DIA by polling.

While the data file DF is input in the drag and drop system in each of the aforementioned preferred embodiments, another system may alternatively be employed. For example, the data file DF may be input in the input area DIA in the copy and paste system.

Further, the contents of the processing of the execution part 174, 275 or 375 on the data file DF are not restricted to the above description. In other words, the data file processor 1, 2 or 3 according to the present invention can execute various data file processing generally executed in a computer.

While the data file processor 1, 2 or 3 displays the status display area DSA in association with the operation of the execution part 174, 275 or 375 in each of the aforementioned preferred embodiments, the display area DSA may alternatively be displayed in the processing content set area DEA from the first.

Further alternatively, the data file processor 1, 2 or 3 may display the status display area DSA on the display part 12, 22 or 32 independently of the processing content set area DEA.

While the invention has been shown and described in detail, the foregoing description is in all aspects illustrative and not restrictive. It is therefore understood that numerous modifications and variations can be devised without departing from the scope of the invention.

1. A data file processor performing prescribed processing on a data file, comprising:
an operating part;
a display part;
an output part displaying a processing content set area corresponding to a processing content on said display part;
a creation part creating an input area for inputting said data file in said processing content set area;
a parameter set part setting a parameter necessary for executing processing corresponding to said processing content set area to which said input area belongs for said input area;
an input part inputting said data file specified by said operating part in said input area; and
an execution part executing processing of said data file input in said input area, wherein
said execution part executes said processing corresponding to said processing content set area to which said input area belongs with said parameter set for said input area.

2. The data file processor according to claim 1, further comprising a processing content set part setting a processing content on the basis of an operation from an operator, wherein
said output part displays said processing content set area corresponding to said processing content set by said processing content set part on said display part.

3. The data file processor according to claim 1, wherein
said output part displays a plurality of processing content set areas corresponding to a plurality of processing contents on said display part.

4. The data file processor according to claim 1, wherein
said creation part creates a plurality of said input areas in said processing content set area, and
said parameter set part is capable of setting different parameters for the respective ones of said plurality of input areas.

5. The data file processor according to claim 1, further comprising a status output part displaying the status of said processing in said execution part on said display part.

6. The data file processor according to claim 1, further comprising an identification part identifying whether or not said processing corresponding to said processing content set area to which said input area belongs is executable for said data file when said data file is input in said input area.

7. The data file processor according to claim 6, wherein
said identification part performs said identification by identifying the attribute of said data file.

8. The data file processor according to claim 7, wherein
said identification part inhibits input of said data file when determining that said processing is inexecutable for said data file.

9. A data file processing method executed in an apparatus having an operating part and a display part, including steps of:
a) displaying a processing content set area corresponding to a processing content on said display part;
b) creating an input area for inputting a data file in said processing content set area;
c) setting a parameter necessary for executing processing corresponding to said processing content set area to which said input area belongs;
d) inputting said data file specified by said operating part in said input area; and
e) executing processing of said data file input in said input area, for executing said processing corresponding to said processing content set area to which said input area belongs with said parameter set for said input area receiving said data file.

10. The data file processing method according to claim 9, further including a step f) of setting a processing content on the basis of an operation from an operator, for displaying said processing content set area corresponding to said processing content set in said step f) on said display part in said step a).

11. The data file processing method according to claim 9, displaying a plurality of processing content set areas corresponding to a plurality of processing contents on said display part in said step a).

12. The data file processing method according to claim 9, creating a plurality of said input areas in said processing content set area in said step b), and capable of setting different parameters for the respective ones of said plurality of input areas in said step c).

13. The data file processing method according to claim 9, displaying the status of said processing on said display part in said step e).

14. The data file processing method according to claim 9, identifying whether or not processing corresponding to said processing content set area to which said input area belongs is executable with respect to said data file input in said input area in said step d).

15. The data file processing method according to claim 14, performing said identification by identifying the attribute of said data file input in said input area.

16. The data file processing method according to claim 15, inhibiting input of said data file when determining that said processing on said data file is inexecutable.

17. A program installable in a computer having an operating part and a display part for making said computer carry out the following steps in order to perform processing on a data file:
a) displaying a processing content set area corresponding to a processing content on said display part;
b) creating an input area for inputting said data file in said processing content set area;
c) setting a parameter necessary for executing processing corresponding to said processing content set area to which said input area belongs for said input area;
d) inputting a data file specified by said operating part in said input area; and
e) executing processing of said data file input in said input area, for executing said processing corresponding to said processing content set area to which said input area belongs with said parameter set for said input area receiving said data file in said step e).
